(19) United States
(12) Patent Application Publication
(10) Pub. No.: US 2016/0021221 A1
(43) Pub. Date: Jan. 21, 2016

(54) INTEGRATED NETWORK INTERFACE SUPPORTING MULTIPLE DATA TRANSFER PROTOCOLS

(71) Applicant: Avago Technologies General IP (Singapore) Pte. Ltd., Singapore (SG)

(72) Inventors: Neil James JOHNSON, Singapore (SG); Kiwon CHANG, Singapore (SG); Shawn Adam CLAYTON, Singpore (SG)

(21) Appl. No.: 14/870,639

(22) Filed: Sep. 30, 2015

Related U.S. Application Data
(63) Continuation of application No. 10/653,767, filed on Sep. 3, 2003, now abandoned.

(51) Int. Cl. H04L 29/06; H04L 12/26

(52) U.S. Cl. CPC H04L 69/18; H04L 69/08; H04L 43/0894; H04L 43/18

(57) ABSTRACT

more high-speed network data transfer protocols that are based on different standards of network data transfer architectures, wherein an incoming data stream formatted in accordance with a particular network data transfer standard is processed into data not subject to the network data transfer standard to be output for further processing by a host. In one aspect, a network interface device is provided with a set of shared or common protocol independent physical link components that are used to identify the operating protocol of the incoming data, and a set of dynamically or statically re-configurable, shared or common protocol independent data transfer processing components that support data exchange via the physical link components for all the supported protocols, which may include a protocol specific link interface for each supported protocol.

### BACKGROUND OF THE INVENTION

1. Field of the Invention

This invention relates to network interfaces, and more particularly to network interfaces for interfacing network elements to an information exchange network that supports multiple network data transfer protocols.

2. Description of Related Art

In information exchange networks, data transfer among network elements may be based on a number of available protocols. Network elements may include computer systems (e.g., workstations, servers, etc.), peripheral devices (e.g., mass storage systems, input/output systems, etc.), and other general function or function specific systems and devices. For example, servers may be configured to communicate with peripheral devices via protocols in accordance with several established industry standards, such as Fibre Channel (FC), Internet Small Computer Systems Interface (iSCSI), Ethernet, etc. Different network elements may adopt a different protocol, which may coexist in a particular physical network, but defining different logical networks for the different protocols. Each network element must be configured to operate with the desired data transfer protocol or protocols.

Host Bus Adapters (HBAs) are hardware devices that expand network elements' ability to work with other network elements under a specific data transfer protocol. HBAs are usually configured in the form of expansion cards (e.g., printed circuit boards) that plug into the data bus of the network elements. A HBA includes certain level of control electronics (e.g., Application Specific Integration Circuit or ASIC) for handling data transfer under a particular operating protocol. For example, HBAs supporting FC are commercially available for use with Storage Area Networks (SANs) that are based on FC data transfer protocols for connecting servers and storage systems. Additional HBAs supporting other protocols (e.g., iSCSI) would be required to transfer data based on the other protocols. Accordingly, this creates inherent inefficiencies in manufacturing and inventory control for suppliers to satisfy deliveries of HBAs for the various protocols. It is often difficult to forecast relative demands among HBAs of the various protocols especially when dealing with a combination of established and emerging technologies, such as between FC, an established storage protocol, and iSCSI, an emerging storage protocol.

Further, for a network in which data are being transferred based on different protocols, separate HBAs must be provided, each for handling data transfer based on the corresponding different protocol. For example, for a SAN that handles data transfer in both FC and iSCSI protocols, two HBAs, one dedicated to handling data transfer based on iSCSI and another dedicated to data transfer based on FC, are required to be installed in each and all network elements that are to be multi-protocol enabled. This results in additional expansion cards to be incorporated in a network element, thus increasing the number of devices and associated costs.

A multiprotocol HBA designed for use with the multilayered FC data transfer architecture is referred to in a publication by Hitachi Data Systems: “Multiprotocol Fibre Channel: The Foundation for Server and Storage Data Networks” (publication data unknown; copyright year 2000). The publication stated that the HBA implements intelligent controllers that support several upper layer protocols (specifically FC-VI, FC-IP and FC-SCSI) that are based on the same multilayered FC architecture on the same HBA. However, the multiple protocols are all based on the FC standard at the base or physical layer of the multilayered FC architecture. The multiprotocol HBA provides simultaneous network connections at the three different FC protocols, which appears to replace the function of fabric switches otherwise required to switch among the protocols for different network connections.

There are commercially available HBAs that are designed to handle data transfers at different speeds with respect to a single network data transfer protocol, standard or architecture. For example, there exists HBAs that are designed to be operable between 100 Mb and 10 Mb Ethernet, or between 2 Gb and 1 Gb FC, or between USB 2.0 and USB 1.1. However, these HBAs are not designed to be interoperable between different network protocols, such as between 10 Gb FC and 10 GB Ethernet.

Currently, there are no known commercial embodiments of HBAs for handling two or more data transfer protocols at different network data transfer standards or architecture in a single HBA.

Multi-protocol switches are available to allow for compatible data exchanges between networks operating in different network data transfer standards. They do not process data that is subject to a particular network data transfer standard to data not subject to any network data transfer standard (or network protocol independent data or machine specific data). Example of such switches are disclosed in U.S. Pat. No. 6,400,730. This type of switches essentially transforms data in one network data transfer standard (e.g., FC) to data in another network data transfer standard (SCSI) via “fabric switches”, and is relatively costly to implement.

PCT Publication No.: WO 99/33243 discloses a digital communications device for enabling communication between the host bus of a user computer and any one of ADSL, ISDN, ATM, cable and wireless networks. The device includes a host adaptor, a dynamically reconfigurable extension port bus coupled to the host adaptor, and a series of “network specific attachment units” coupled to the extension port bus and the networks. The host adapter has an extension port coupled to the external extension port bus and a host bus interface controller coupled to the external host bus. According to said publication, the device automatically detects and identifies the presence and type of a particular network specific attachment unit that is active, and initiates the loading of appropriate software for reconfiguration of extension port bus for compatibility with the detected and identified active network specific attachment unit. The device disclosed in the publication is therefore directed to a network adapter that reconfigures at the bus level to provide data compatibility with several types of networks. As such, the disclosed device is designed for relatively low speed networks compared to FC or iSCSI SAN networks that operate at speeds on the order of 10 Gbits/s or higher.

It is therefore desirable to provide an integrated network interface device that is configured to work with more than one high-speed network data transfer protocols.

### SUMMARY OF THE INVENTION

The network interface device of the current invention overcomes the limitations of the prior art. The present invention provides an integrated network interface device that supports date exchange in two or more high-speed network data transfer protocols that are based on different standards of network data transfer architectures, wherein an incoming data stream formatted in accordance with a particular network data transfer standard (i.e., network protocol dependent data) is processed into data not subject to the network data transfer standard (i.e., network protocol independent data, or machine specific data) to be output for further processing (e.g., by a server). The present invention is particularly useful for interfacing data exchange at relatively high-speed or broad bandwidth, such as on the order of 10 Gbits/s or higher.

In a basic aspect of the present invention, an integrated high-speed network interface device is provided with two or more sets of components in a single device, each set supporting a single protocol.

In an enhanced aspect of the present invention, a network interface device is provided with a set of shared or common protocol independent physical link components that are used to identify the operating protocol of the incoming data, and a set of dynamically or statistically re-configurable, shared or common protocol independent data transfer processing components that support data exchange via the physical link components for all the supposed protocols, which may include a protocol specific link interface for each supported protocol.

In one embodiment of the network interface device of the present invention, dynamic protocol detection is provided wherein the shared physical link components are configured in dynamically detect the network data transfer protocol and set the corresponding reference clock rate for processing the detected protocol. In one embodiment, the physical link components include different reference clock signals (derived from same or different reference clocks) for each supported protocol and a link monitor and speed selector (LMSS) component.

In another embodiment of the network interface device, static protocol selection is provided wherein the shared physical link components are configured by hardware re-configuration (e.g., jumpers), software (e.g., software settable switches) or firmware components (e.g., ASIC) that may be programmed by the user or manufacturer to set the physical link components to work with one of the available network data transfer protocols supported by the network interface device.

In a further embodiment, the set of data transfer processing components includes protocol specific link interfaces for each supported protocol, a protocol independent media interface layer (MIL) component, one or more protocol independent processing units (e.g., CPUs) for receiving and implementing firmware code for data transfer interface control.

In another aspect of the present invention, a multi-protocol HBA (MPHBA) is configured with the integrated multi-protocol network interface of the present invention, and a host bus interface for interfacing the MPHBA with the network element in which it is deployed.

In a basic embodiment, the MPHBA is provided with two or more separate sets of protocol processing components (e.g., implemented in an ASIC), wherein each set of components includes protocol specific components that support a different protocol and protocol independent components.

In an improved embodiment of the MPHBA, the set of data transfer process components is implemented in an ASIC, which may include protocol specific link interfaces for each supported protocol, a shared or common protocol media interface layer (MIL) component, one or more processing units (e.g., CPUs) for receiving and implementing firmware code to control system operation, a buffer controller.

In still soother aspect of the present invention, the MPHBA can be implemented as an integrated part of the system board, or other components of a network server or other network elements, and further integration in a network (e.g., a SAN).

### BRIEF DESCRIPTION OF THE DRAWINGS

For a better understanding of the present invention, as well as the best mode, reference should be made to the following detailed description read in conjunction with the accompanying drawings. In the following drawings, like reference numerals designate like or similar parts throughout the drawings.

FIG. 1 is a schematic block diagram of a MPHBA illustrating a basic embodiment of an integrated network interface of the present invention.

FIG. 2 is a schematic block diagram of a MPHBA illustrating another basic embodiment of an integrated network interface of the present invention.

FIG. 3 is a schematic block diagram of a MPHBA in accordance with an enhanced embodiment of the present invention.

FIG. 4 is a schematic block diagram of the MIL in accordance with one embodiment of the present invention.

FIG. 5 is a process flow diagram depicting the operational flow of the firmware in accordance with one embodiment of the present invention.

FIG. 6 is a schematic representation of a PCI based MPHBA according to one embodiment of the present invention.

FIG. 7 is a schematic block diagram of the shared physical link components in accordance with one embodiment of the present invention.

FIG. 8 is diagram depicting the control process flow of the link monitor and speed selector of the current invention.

FIG. 9 is a schematic system diagram depicting the deployment of a MPHBA in a SAN, in accordance with one embodiment of the present invention.

### DETAILED DESCRIPTION OF THE PREFERRED EMBODIMENT

The present description is of the best presently contemplated mode of carrying out the invention. This description is made for the purpose of illustrating the general principles of the invention and should not be taken in a limiting sense. The scope of the invention is best determined by reference to the appended claims. This invention has been described herein in reference to various embodiments and drawings. It will be appreciated by those skilled in the art that variations and improvements may be accomplished in view of these teachings without deviating from the scope and spirit of the invention.

All publications referenced herein are fully incorporated by reference as if fully set forth herein.

The present invention can find utility in a variety of implementations without departing from the scope and spirit of the invention, as will be apparent from an understanding of the underlying principles. By way of examples and not limitation for purposes of describing the inventive aspects of the present invention, references are made throughout this description of the invention to MPHBA systems for use in a computer network environment. However, it is understood that various aspects of the present invention, including but not limited to the multi-protocol capable circuit and associated multi-protocol detection and selection features of the present invention may be applied to other types of electronic devices operating in a multi-protocol network environment. It is further understood that while the present invention is explained in reference to she iSCSI, FC and Ethernet protocols, it can be applied to other network communication protocols.

By way of examples and not limitation, the MPHBA described hereinbelow are dual protocol HBAs, and the network environment illustrated is a SAN. However, the present invention may be extended to operate with more than two protocols in other types of network without departing from the scope and spirit of the present invention.

### System Overview/Design Considerations

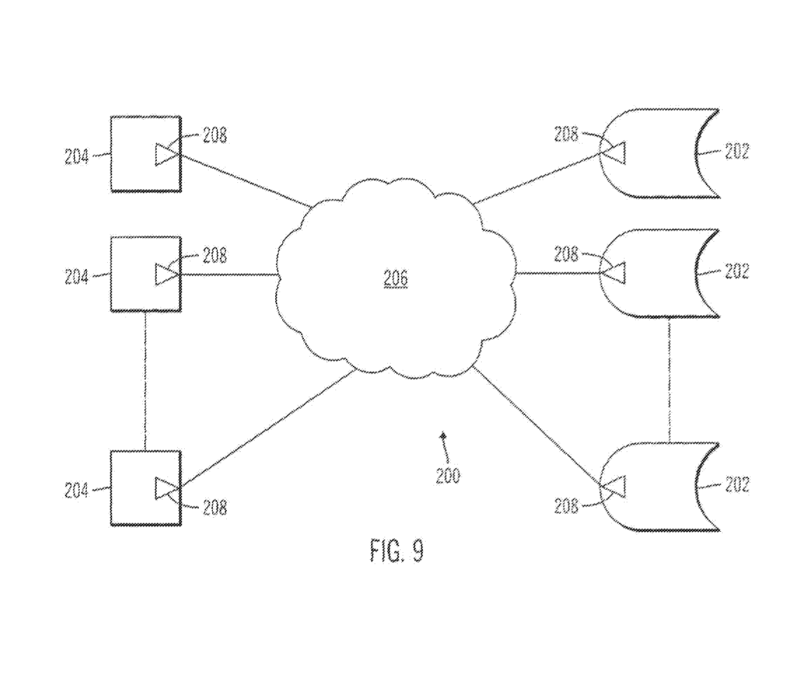

FIG. 9 is a schematic diagram illustrating art embodiment of a SAN 200 that deploys the network interface device of the present invention. The SAN 200 generally includes a number of network elements such as storage devices 202 and servers 204, which communicate over an information exchange network 206. The storage devices 202 may be hard drives, tape drives and optical drives, etc., configured as, for example, redundant array of independent disks (RAID), part of a larger systems such as servers, a combination of the foregoing, or standalone systems. The information exchange network 206 may include the Internet, a proprietary local area network, a wide area network, telecommunications networks, broadcast networks, wired or wireless networks, etc., and may include a combination of some or all of the foregoing.

The network 206 may support data communication based on one or more protocols in accordance with different established network data transfer standards or architectures, and may include separate and/or interconnected sub-networks that support one or more data transfer protocols. In one aspect of the present invention, the supported protocols comprise storage level protocols (e.g., for SANs). In a further aspect, the supported protocols comprise block level, frame and/or packet-based protocols (e.g., FC, iSCSI, etc.). The illustrative embodiments described herein below rely on networks that are capable of sharing the same physical connection (fibre, electrical cable and connector) to the network.

Details of various hardware and software, components comprising the network 206 are not shown (such as routers, gateways, switches, etc,) as they are well known in the art. Further, it is understood that access to the network 206 by the network elements may be via physical transmission medium (e.g., optic fiber) suitable for the particular network data transfer protocols supported by the network elements.

The present invention enables a network element (e.g., server 204 and/or storage devices 202) to interface with the network 206 using more than one protocol in accordance with established network data transfer standards supported by the network. The present invention provides an integrated network interface device 208 that supports data exchange in more than one network data transfer protocol, wherein an incoming data stream formatted according to a particular network data transfer protocol (i.e., network protocol dependent data) is processed into data that is not subject to the network data transfer protocol (i.e., network protocol independent data, or machine specific data) to be output for further processing (e.g., by the server 204). This may be implemented in a basic configuration by integrating two or more sets of protocol processing components in a single device, each set supporting a single protocol. In an improved configuration, the level of integration extends to a shared component configuration in which certain processing components are shared or common to the supported protocols, including shared or common physical link components that are used to identify the operating protocol of the incoming data, and a set of data transfer processing components that support incoming and outgoing data in more than one protocol via the physical link components, which may include shared or common components for the supported protocols and a protocol specific link interface for each supported protocol.

By way of examples, the network interface device 208 of the present invention may be implement in the form of an MPHBA. MPHBAs configured in accordance with the current invention provide a low cost network interface for use in computing networks, which enable quick and reliable interface of network elements to a network (such as servers 204 and/or storage devices 202 to the network 206), using two or more data exchange protocols (such as Ethernet and FC) using a combination of protocol specific and protocol independent components.

There are a number of benefits in supporting multiple networking protocols of different standards, such as FC and Ethernet. FC is an established storage networking protocol that is in widespread use, and iSCSI (over Ethernet) is an emerging storage protocol. Having a single MPHBA that can either dynamically or statically be made to support either protocol allows increased efficiency and cost effectiveness over current MPHBA designs. For instance, a user may initially choose to use the MPHBA of the present invention on a FC network, while allowing for later transition to an iSCSI network without having to remove or add hardware components. Another benefit of the system of the present invention is the efficiency gained in manufacturing and inventory control. A single card can be manufactured and stocked which can satisfy deliveries for either protocol. This eliminates the need to forecast relative demands between the two protocols, which is something that is often difficult when dealing with a combination of established and emerging technologies.

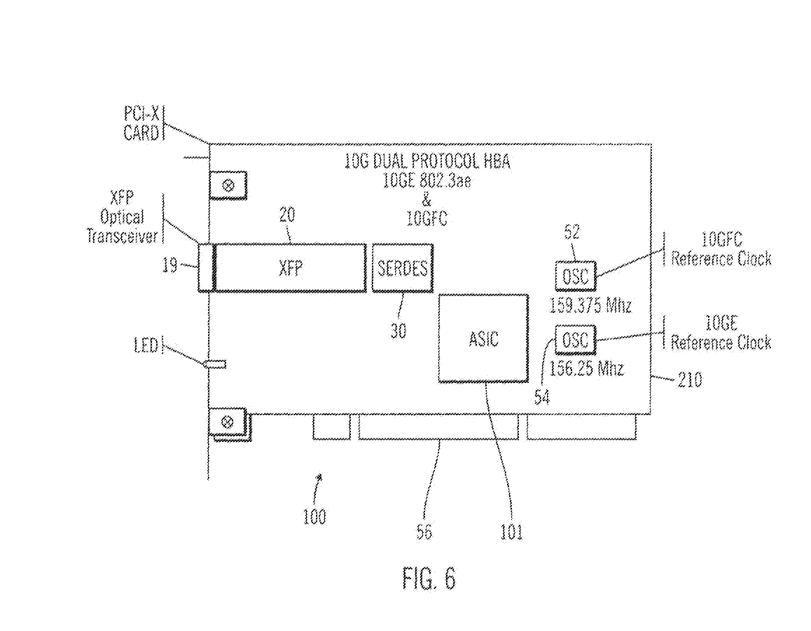

In one embodiment of the present invention, the network interface device 208 of the present invention may be implemented in the form of a peripheral card 210 (e.g., a PCI card) as schematically shown in FIG. 6, or may be integrated within the system components of the network elements (e.g., storage devices 202 and/or servers 204 in FIG. 9). When the MPHBA is implemented as a peripheral card 210, it can interface with the system components (e.g., system board, CPU, memory devices, system bus, etc.) of the network elements. For example, it can interface with a PCI box in a server by coupling the connectors 56 to a PCI slot (not shown) in the server. More than one MPHBA may be deployed in a particular network element.

### Basic MPHBA Integration

In a basic aspect of the present invention, the integrated network interface device is provided with two or more sets of components in a single device, each set supporting a single protocol.

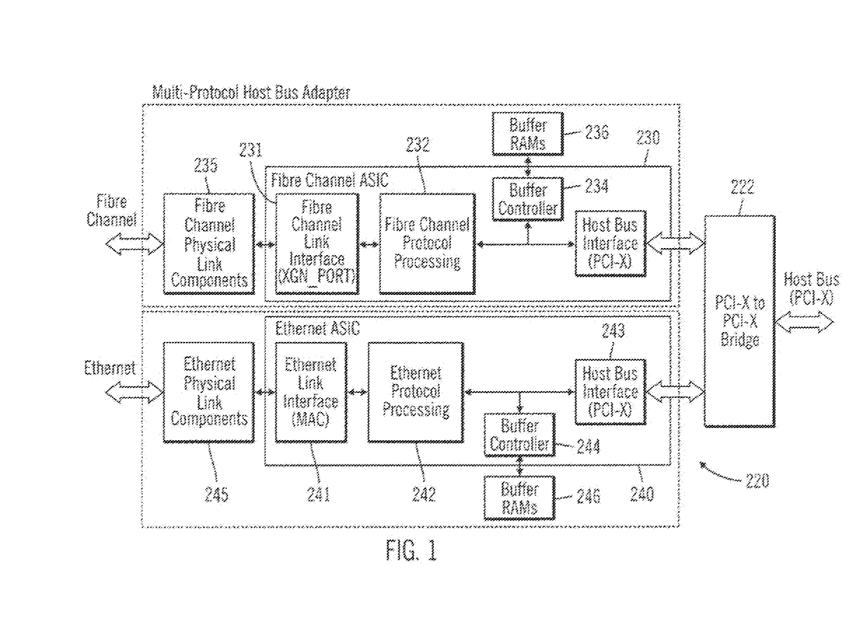

FIG. 1 is a schematic block diagram of a MPHBA 220 in accordance with one embodiment of the present invention, which is designed to operate with Ethernet (or 10 Gb iSCSI) and FC protocols. The MPHBA 220 is implemented with two protocol specific ASICs 230 and 240, each provided with its own set of protocol specific and protocol independent blocks. Specifically, for the FC link, the ASIC 230 is provided with an FC link interface 231, an FC protocol processing block 232, a host bus interface 233 and a buffer controller 234 that controls external buffer RAMs 236, which components are coupled in the manner shown in FIG. 1. The ASIC 230 is coupled to FC physical link components 235. The Ethernet link, its components essentially mirror that of the FC link, except that the FC protocol specific components have been replaced by counterpart Ethernet protocol specific components. Specifically, the ASIC 240 is provided with an Ethernet link interface 241, an FC protocol processing block 242, a host bus interface 243 and a buffer controller 244 that controls external buffer RAMs 246, which components are coupled in the manner shown in FIG. 1. The output of the ASICs 230 and 240 are coupled to a common PCI bridge 222 to the host bus. In this embodiment, there are several components that are duplicated across the two protocols.

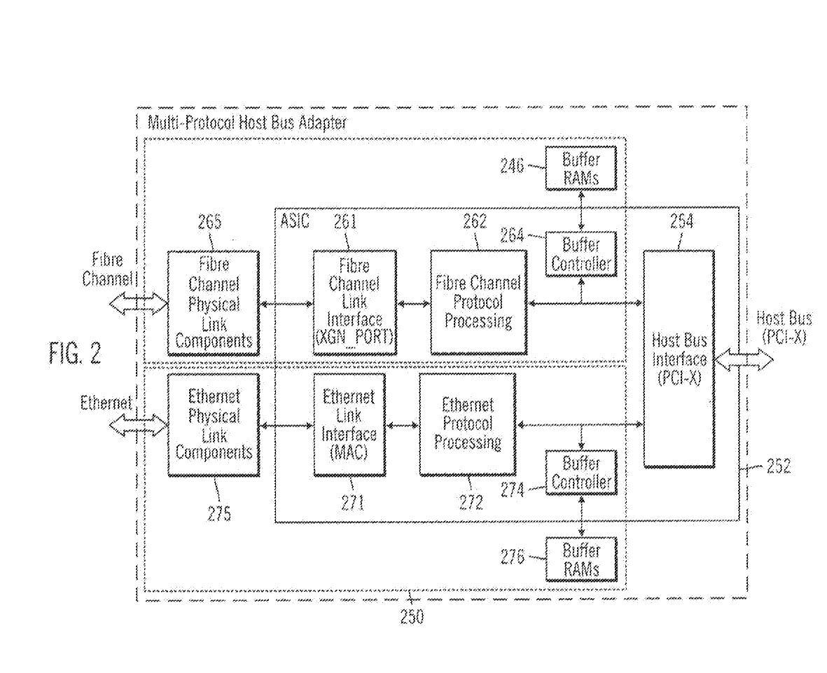

FIG. 2 shows an improvement over the MPHBA shown in FIG. 1. In this embodiment, both protocols (Ethernet/10 Gb iSCSI and FC protocols) of the MPHBA 250 have been integrated onto a single ASIC 252, which reduces some cost and complexity. The ASIC 252 is essentially a combination of the two ASICs 230 and 240 in FIG. 1, except that a common host has interface 254 is provided for interfacing the host bus. For the FC link, the ASIC 252 defines an FC link interface 261, an FC protocol processing black 262, a host bus interface 263 and a buffer controller 264 that controls external buffer RAMs 266, which components are coupled in the manner shown in FIG. 2. The FC link interface 261 of the ASIC 252 is coupled to external FC physical link components 265. The ASIC 252 also defines a set of components that essentially mirror that of the FC link, except that the FC protocol specific components have been replaced by counterpart Ethernet protocol specific components. Specifically, the ASIC 252 defines an Ethernet link interface 271, an FC protocol processing block 272, a host bus interface 273 and a buffer controller 274 that controls external buffer RAMs 276, which components are coupled in the manner shown in FIG. 2. The Ethernet link interface 271 of the ASIC 252 is coupled to external Ethernet physical link components 275.

The basic integration configurations described above offer support of multiple network data transfer protocols on a single device for high speed data transfer applications, for example in a SAN, in which data transfer rates are on the order of 10 Gbits/s or higher.

### Enhanced MPMBA Integration

In an enhanced aspect of the present invention, a network interface device is provided with a level of integration that extends to a set of shared or common protocol independent physical link components that are used to identify the operating protocol of the incoming data, and a set of dynamically or statically re-configurable, shared or common protocol independent data transfer processing components that support data exchange in more than one protocol via the physical link components. The data transfer processing components may include a protocol specific link interface for each supported protocol.

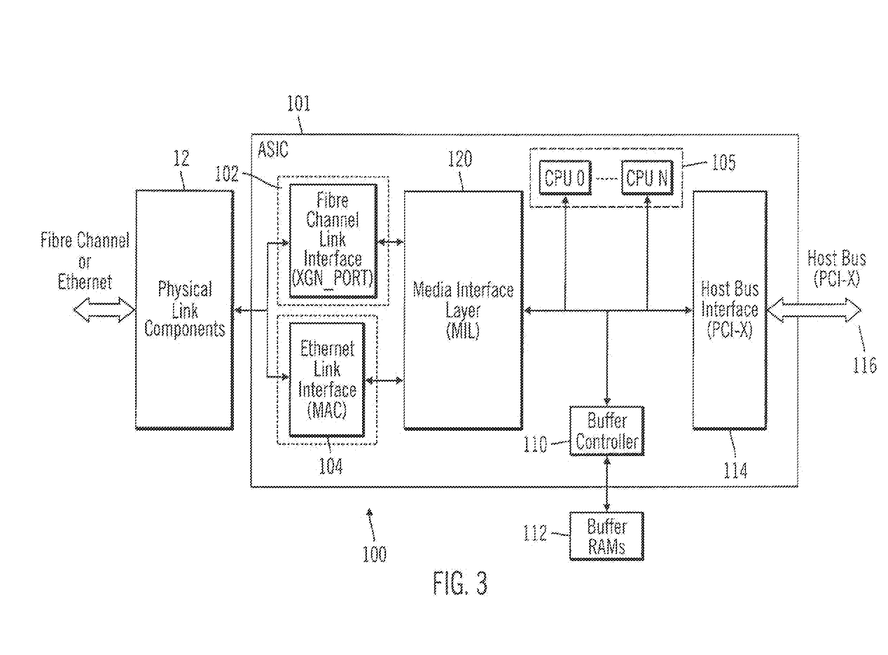

FIG. 3 illustrates an improved MPHBA 100 in accordance with an embodiment of the present invention. In this embodiment, the higher level of integration includes configuring protocol independent physical link components 12 that is common or shared by Ethernet and FC links to the MPHBA 100, and additional shared protocol independent components that may be defined in an ASIC 101, including a protocol independent media interface layer (MIL) 120, one or more processing devices or CPUs 105 (CPU 0 to CPU N) for receiving and implementing firmware code for data transfer interface control, buffer controller 110, and a host bus interface 114 interfacing a host bus (e.g., a PCI bus) in the network element (e.g., a server) in which the MPHBA 100 is installed. While the physical link components are shown to be outside of the ASIC 101 on the MPHBA 100, alternatively, it can also be configured within the ASIC 101, as shown by the implementation of the MPHBA 100 as a peripheral card 210 illustrated in FIG. 6.

Limited separate protocol specific components are configured in the MPHBA 100, such as FC link interface 102 and Ethernet link interface 104, which may also be defined in the ASIC 101. The structure and functions of the various components are further discussed below.

### ASIC

The ASIC 101 interfaces the MPHBA to the host network element (e.g., to a host server via a PCI bus via a multi-tab connector 56 as shown in FIG. 6). The ASIC 101 on the MPHBA 100 contains separate blocks for handling the low-level frame details of each protocol. In the particular embodiment shown in FIG. 3, one block is the FC link interface 102 (XGN_PORT in the illustrated system), and the other is the Ethernet link interface 104 (10G_MAC in the illustrated system). These blocks handle the low-level differences in the protocol, such as start-of-frame markers, end-of-frame markers, frame CRCs, and link level flow control. These blocks have a frame-level interface with a common block, the MIL 120, to which they pass all received frames, and from which they get all frames that are to be transmitted.

In this embodiment, a single ASIC 101 is shown to define the particular shared protocol independent components. It is understood that such components may be distributed in more than one ASIC but preserving the same shared functions, without departing from the scope and spirit of the present invention. Further, one or more of the shared components in the ASIC 101 may be excluded from the ASIC 101 and instead defined on the MPHBA without departing from the scope and spirit of the invention.

### Media Interface Layer (MIL)

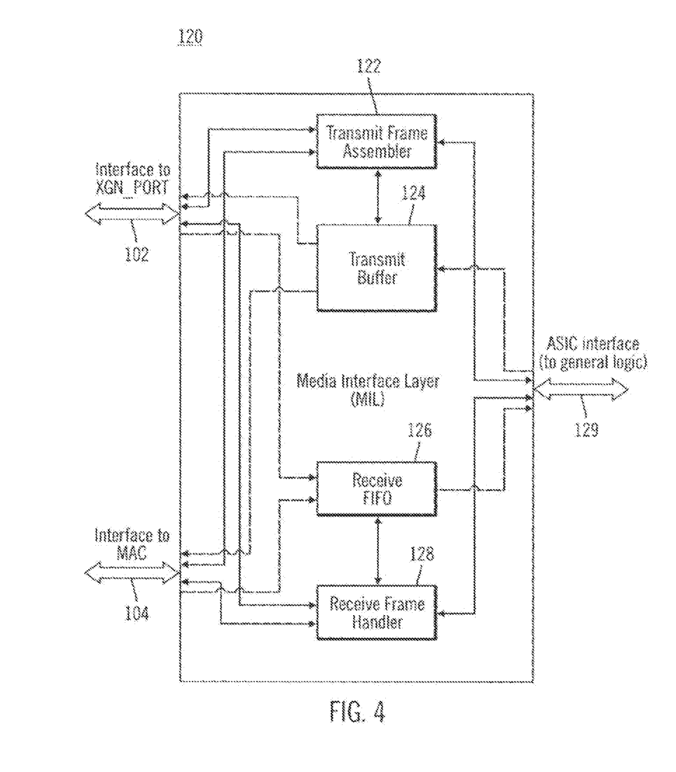

The MIL 120 is an ASIC block that handles interactions of the data stream at the frame level. FIG. 4 is a schematic block diagram showing the functional components of the MIL 120. Logical connections that handle frame “payload” transfers are depicted in FIG. 4 by dotted lines, as distinguished front “control” type connections. The MIL 120 performs two primary functions, assembling frames for transmission and handling frames that are received. The transmit function of the MIL 120 is handled by functional components including a transmit buffer 124 and a transmit frame assembler 122. The transmit buffer 124 is used as a storage location where frames to be transmitted are assembled according to rules required by the protocol of the data stream. The transmit buffer 124 implements general logic that can be used for either supported protocol, and may be implemented using an SRAM of a size appropriate to handle the assembly of one or more transmitted frames. The transmit buffer 124 is preferably sized such that sufficient space is available to assemble frames for transmission while other frames are actually being transmitted, e.g., for two or more frames. Frame sizes for FC are 2112 bytes, and 9K bytes for “jumbo” Ethernet. Thus, a buffer size of 18K bytes or greater (two or more “jumbo” Ethernet frames) is typically required. The actual transmission function may follow the form typically used by single protocol adapters, since each protocol has its own link interface block (e.g., 102, 104 in FIG. 3).

The transmit buffer 124 is connected such that it receives frame payload information from the ASIC interface 129 that is coupled to the other blocks of the ASIC 101 shown in FIG. 3, and it can move frame payload to either the XGN_PORT (FC link interface 102) or the MAC (Ethernet link interface 104), as appropriate for the chosen protocol.

The transmit frame assembler 122 is responsible for constructing frames in the transmit buffer 124 under the direction of protocols the CPUs 105 (CPU 0 to CPU N), and coordinating the flow of data from the ASIC interface 129 to the transmit buffer 124 and from the transmit buffer 124 to either the XGN_PORT or the MAC, as appropriate. The transmit frame assembler 122 assembles transmit frames using frame descriptions formatted by the CPUs 105 that are in a protocol independent format, and that may describe how to assemble either FC or Ethernet (iSCSI) frames for transmission. The transmit frame assembler 122 then assembles the frames and presents them to the appropriate link interface block for actual transmission. Thus, the transmit frame assembler 122 may contain logic that are specific to the protocols, as it my need to assemble frames for either protocol and interface with the appropriate control interface of the XGN_PORT and MAC, which may have protocol specific features. For example, for the FC protocol, the handling of buffer-to-buffer credits may be allowed through the transmit frame assembler 122, a feature which is not required for Ethernet. The transmit frame assembler 122 may also contain general logic common to both protocols, such as that which controls the data movement, and that which decodes the frame assembly instructions received from the CPUs 105.

The receive function of the MIL 120 is handled by the functional components including a receive FIFO 126, and a receive frame handler 128. The receive FIFO 126 couples to both the XGN_PORT and the MAC, from which it receives frame data, and transfers frame data over the ASIC interface 129 to the buffer controller 110 and buffer RAMs 112. The receive FIFO 126 is responsible for providing temporary storage of received frames where they can be examined before being transferred to the ASIC buffer controller 110 and buffet RAMs 112. The receive FIFO 126 implements general logic that is used for either protocol, and may be implemented using an SRAM sized to store frame data sufficient to provide any buffering required to prevent data loss due to any delays in moving data to the ASIC buffer controller 110 and/or buffer RAMs 112. The receive FIFO buffer size is also dependent on the actual implementation of the device, and may be sized such that it is large enough to act as an “elastic buffer” between the frames being received from the network, and the data being written into the buffer RAMs 112. When a frame is being received from the network, it may take some period of time to start transferring the frame into the buffer RAMs 112. During this time the frame (or additional frames, as the case may be) may continue to be received from the network. The receive buffer should preferably be large enough to hold any data received from the network while waiting for data to start being transferred to the buffer RAMs 112. Typically this size is some fraction of a frame, but may be larger than a frame if the latency to transfer data to the buffer RAMs 112 is high.

In addition to being an “elastic buffer”, the purpose of the receive FIFO 126 is also to provide information on the frame(s) currently being received to the receive frame handler 128. The receive frame handler 128 is responsible for coordinating the movement of frame data from the XGN_PORT or the MAC, through the receive FIFO buffer 126, and out the ASIC interface 129 to the ASIC buffer controller 110 and buffer RAMs 112. It is also responsible for performing some amount of frame classification, and providing the protocol CPUs 105 with frame arrival notification and frame classification information. As such, the receive frame handler 128 contains logic that is general, and applicable to both protocols, such as the frame data movement and arrival notification mechanisms, and also logic that is specific to each protocol, such as the frame classification function, which depends on the specific frame header formats of each protocol.

### Protocol CPUs

The protocol CPUs 105 perform the bulk of the protocol specific processing. The CPUs 105 run firmware that is required for processing the protocol appropriate for the network to which the MPHBA is currently connected. The firmware routines include those that are common for the protocols supported by the MPHBA 100 and those that are protocol specific for each supported protocol. The common routines include routines that deal with the detection of the type of network to which the MPHBA is connected, and routines for buffer management, host bus interface management, and general utilities. The number of CPUs 105 used in a given implementation are chosen such that the specific performance requirements of running the protocol firmware can be met. A greater number of CPUs 105 generally leads to higher performance at the expense of increased size and cost. It is possible to implement the CPUs 105 such that the resources of each are spilt between the two protocols, however, cost and performance may be best optimized by allocating all available CPUs to work on the currently selected protocol.

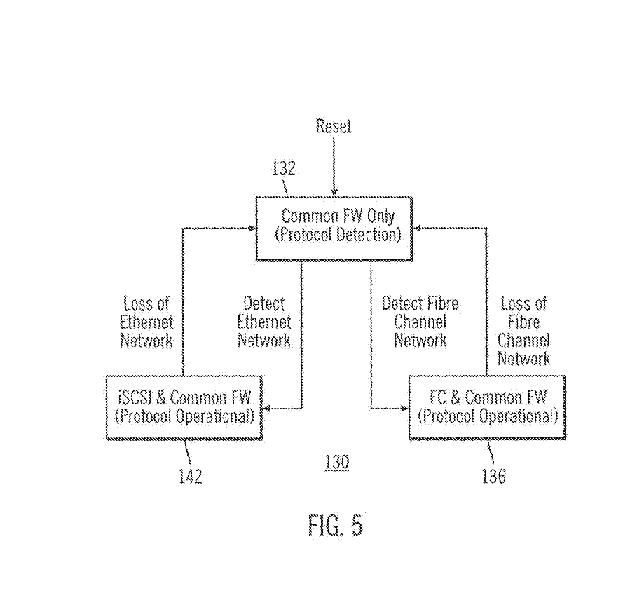

FIG. 5 illustrates the basic process 130 of how the protocol CPUs 105 operate with respect to the dynamic choice of protocol specific firmware (e.g., FC and iSCSI over Ethernet in the illustrated embodiment). The process starts in state 132 where the network link interfaces 102 and 104 (FIG. 3) are “down” (i.e., no valid network is detected). At this point, no protocol specific operational code is loaded into the CPUs' execution memory. The protocol CPUs 105 use common code to detect the type of network, if any, that is attached to the MPHBA 100.

Once the protocol CPUs 105 have detected the network protocol type, they transition to a corresponding state that loads and executes the corresponding operational firmware for the detected protocol (i.e., in either FC firmware state 136 or iSCSI firmware state 142). It is in these states that communication connections are made and data is transferred in the methods as specified by the detected protocol. Should, during this operational state, the firmware detects (as indicated by the common code that provides such function) that one of the link interfaces 102 and 104 has been connected to a network of some other protocol or no network has been connected, the operational code for that protocol will be shut down, and the execution flow will return to the state 132, where the common code detects the protocol of the network, if any, that is attached. The process then transitions to the operational code of the specific protocol that is detected (which may be the same or different protocol as was previously operational).

While FIG. 5 illustrates the process for two protocols, it is understood that the process may be extended to detect from among three or more supported protocols in MPHBAs or other network interface devices, without departing from the scope and spirit of the present invention.

### Physical Link Components

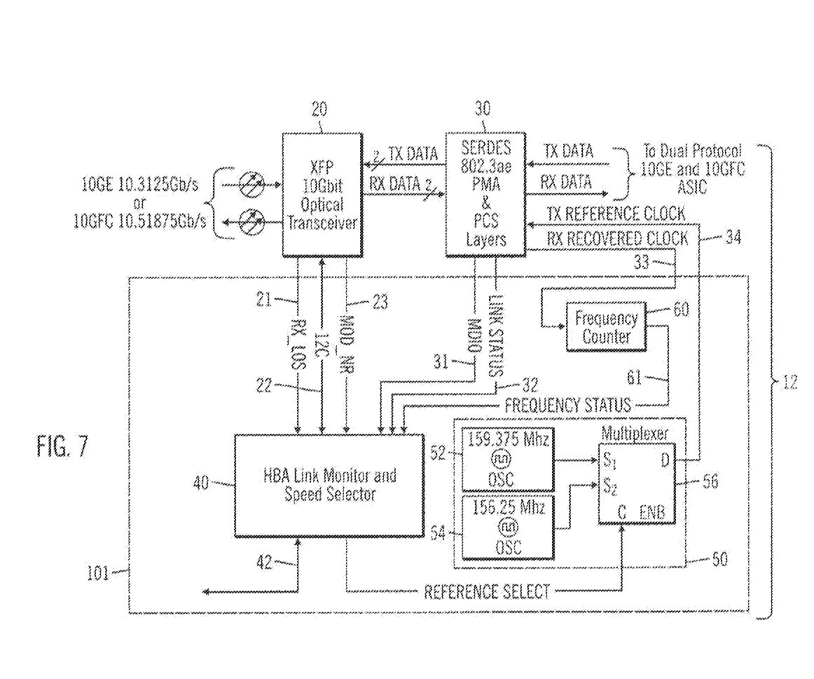

Referring to FIGS. 6 and 7, the physical link components 12 of the MPHBA 100 is configured to include different reference clock signals (derived from a single or different reference clocks in a multiple reference frequency source 50) for each supported protocol and a link monitor and speed selector (LMSS) 40. The physical link components 12 includes a physical interface, which may include at least one physical port 19 to which the network data line is coupled (e.g., a optical fiber cable), and a transceiver, such as in the case of network connection via optical fiber, for converting optical data signals to electronic data signals (e.g., an industry standard optical transceiver XFP 20, or other industry standard optical transceivers such as XPAK and XENPAK optical transceivers of various mechanical packaging). While only one physical interface is shown in FIG. 6, the physical link components 12 may be provided with additional physical ports and/or transceivers for coupling to two or more network connections at the same time. Several ports may share a transceiver and/or other components in the physical link components 12.

Depending on the protocols to be supported, the physical link component 12 may include a serializer/deserializer (SERDES) 30 for transforming between parallel and serial data. Further, the physical link component includes a frequency counter 60, and a multiplexer 56. In the embodiment providing for dynamic protocol detection and selection, the LMSS 40 controls the multiplexer 56 to automatically detect and select the desired frequency of operation for the detected protocol, as further disclosed below. In the embodiment that provides for static protocol setting, the LMSS could be configured by physical or software implementation to set the desired protocol, as further disclosed below.

Unlike conventional HBA implementations, the MPHBA of the present invention provides a multiple reference frequency source 50 to support multiple protocols. In the illustrated embodiment, the MPMBA 100 includes both a 159.375 Mhz oscillator 52 and a 156.25 Mhz oscillator 54 for the 10 Gbit FC and 10 Gbit Ethernet (iSCSI) reference frequencies, respectively. One main difference between these two protocols is the clock rate at which they operate (the Ethernet protocol requires a clock of 159.375 MHz, and FC requires a clock of 156.25 MHz). Each oscillator is exactly 1/66^{th} of the 10 Gbit Ethernet 10.3125 Gbits/s and 10 Gbit FC 10.51875 Gbits/s optical rates.

Adaptation of the single physical link components 12 to the different clock frequencies of the two protocols is discussed in greater detail below. Since the two protocols share the same physical link components in the system, only one protocol can actively use the physical link at a given time. This is generally advantageous as one set of components reduces the cost and area of the MPHBA 100.

The respective Gbit frequencies are derived from the oscillators 52 and 54 by the SERDES 30, by built-in functions at the oscillators 52 and 54, or by a separate component (not shown) within the multiple reference frequency source 50 or otherwise provided on the MPHBA. Depending on the particular protocols to be supported, instead of using multiple oscillators, the multiple reference frequency source 50 may include an oscillator that is based to derive multiple reference clock signals or frequencies at a multiple and/or fraction of the oscillator frequency to support different protocols. For example, frequency synthesis hardware well known in the art could be used in place of the two or more oscillators to generate the necessary reference frequencies for the supported protocols. Alternatively, the multiple reference frequency source 50 may include more than two oscillators to enable support of additional protocols without departing from the spirit and scope of the present invention.

### LMSS

In the embodiment of the physical link components 12 shown in FIG. 7, the LMSS 40 is structured and configured with functions that include: (a) monitoring the status of the XFP 20 and SERDES device 30; (b) controlling the multiplexer 56 to select between 10 Gbit Ethernet and 10 Git FC reference frequencies from oscillators 52 and 54; (c) comparing the selected reference frequency to the actual frequency of the optical interface for the received (RX) signal as determined by a frequency counter 60; and (d) setting the reference frequency for continued operation of the MPHBA 100. In FIG. 7, as in FIG. 6, except for the XFP 20 and SERDES 30, the other shown components of the LMSS may be implemented in the ASIC 101. Compared to FIG. 3, the physical link components 12 that includes the LMSS is shown to be outside the ASIC 101, in an alternate embodiment.

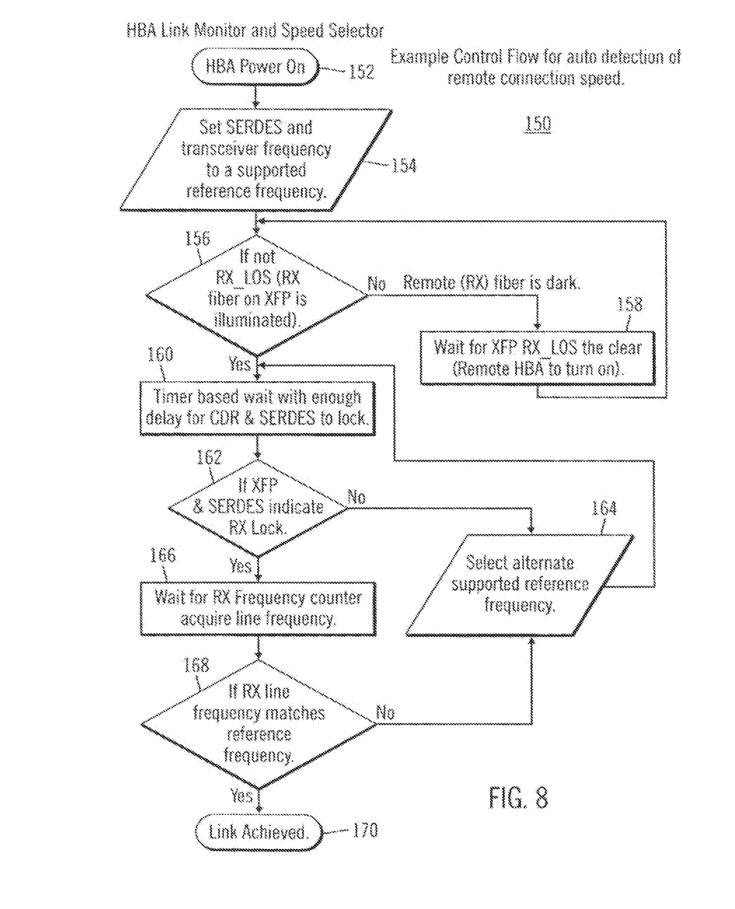

As will be discussed in greater detail below in connection with FIG. 8, the LMSS is involved in the dynamic detection and selection of the operating protocol to which the MPHBA is connected. For the embodiment of static protocol selection, the LMSS may be configured to omit certain components and/or functions that are not applicable to the particular static protocol setting method (e.g., physical or software setting).

When MPHBAs having LMSSs are provided at both ends of a network, it is contemplated that the LMSSs may be configured (e.g., with software) to enable auto-speed negotiation, to automatically defect and connect to the correct frequency of the RX signal.

### Dynamic Protocol Detection/Selection

In one embodiment of the network interface device of the present invention, the operating protocol of the network connection is automatically detected and the operating frequency is dynamically selected. The shared physical link components are configured to automatically and dynamically detect the network data transfer protocol and set the corresponding reference clock rate for processing the detected protocol. For example, the embodiment of the MPHBA 100 illustrated in FIG. 3 and FIG. 6 supports 10 Gbit/s optical interfaces running at both the 10GE 10.3125 Gbits/s and 10GFC 10.51875 Gbits/s optical rates for Ethernet and FC protocol, respectively. The dynamic protocol detection and selection system of the MPHBA 100 supports the automatic detection and/or negotiation of the desired optical rate and protocol, depending on the network to which the MPHBS 100 is coupled.

Referring also to FIG. 8, the flow process undertaken by the physical link components 12 to automatically detect and select the operating protocol is illustrated. The flow control diagram starts with the MPHBA being powered on in state 152. In state 154, the LMSS 40 selects one of the possible operating reference frequencies supported by the MPHBA 100 (i.e., one of two supported frequencies in the illustrated embodiment). This reference frequency is delivered to the SERDES 30 and XFP 20 devices as signal 34, and the MPHBA 100 begins transmitting data at the selected reference frequency to advertise its presence to other devices at the selected rate of operation. In state 156, the loss of signal status of the RX line is monitored. In the case of an XFP transceiver as in the illustrated embodiment, this would be the RX_LOS signal 21, which when “true” or “1” indicates that the RX optical line is “dark”. As ling as the RX optical link is dark, the LMSS 40 waits for “light” (i.e., RX_LOS signal in “false” or “0” state) 158 before auto-detection of link speed can occur.

In state 160, when the RX_LOS signal 21 is in a false state, indicating that the RX optical line has light or signal, the LMSS 40 waits a set amount of time required for the clock and data recovery (CDR) of the XFP 20 and the phase locked loop (PLL) of the SERDES 30 to lock (if possible) onto the RX signal data rate. Reference may be made to the XPF specification created by the XFP Multi Soruce Agreement (MSA) Group, as set forth in the publication “10 Gigabit Small Form Factor Pluggable Module”, Revision 3.1, Apr. 2, 2003 (which publication is fully incorporated by reference herein), and at Section 2.6 “Timing Requirement Of Control and Status I/O”. The publication is currently available from http://www.xfpmsa.org/.

For example, for a CDR and PLL having characteristic response time of less than or equal to 1 msec, the waiting time may be set to less 1 msec. The LMSS 40 polls the status of the XFP 20 and SERDES 30 to determine if lock to the RX signal data rate has been achieved. If there is a “lock” condition, the SERDES provides a LINK STATUS signal 32 to the LMSS 40. The MDIO line 31 is a two wire serial interface which is defined in the IEEE 802.3ae specification (10 Ge), The 10G-FC specification uses the same register definitions. MDIO register 3.8 bit 10 is the “receive fault” status (“1”=fault).

The MOD_NR signal 23 indicates (when low at “0”) that both the receive and transmit CDR are locked (and that no other fault conditions have occurred). The XFP I2C line 22 is a two wire bi-directional bus for access to more detailed status information. XFP I2C address 111 bit 5 is the “TX_CDR not locked” status (“1”=not locked). If the XFP 20 and/or SERDES device 30 has not locked onto the RX signal data rate, the LMSS 40 assumes the initially selected reference frequency in state 154 is incorrect and it selects one of the remaining alternate reference frequencies in state 164. The LMSS 40 then resumes its wait for “lock” in state 160. The resulting effect is the LMSS 40 scans back and forth between the possible optical rates, waiting for lock to occur on the XFP 20 and SERDES 30.

In the event both the XFP 20 and SERDES 30 do indicate a lock condition, however, this is still not sufficient to know that the selected reference frequency matches the RX signal data rate. The CDR and PLL in the XFP 20 and SERDES 30 may still be able to lock onto the RX signal clock, despite the incorrect reference clock begin used. In state 166, because the XFP 20 and SERDES 30 are then locked on to the RX signal clock, the recovered version of this clock signal 33 from the SERDES 30 can be determined with a frequency counter 60. The LMSS 40 determines if the recovered (line) clock signal 33 matches the selected reference clock in state 168. In state 170, if the RX signal clock matches the selected reference clock, then a “link” has been achieved with the network via the optical interface of the MPHBA 100. The LMSS 40 communicates with the rest of ASIC 101 via line 42 the link condition and type of link. RX data and TX data can be transferred between the LMSS 40 and the rest of ASIC 101, which processes the data streams based on the specific identified protocol of the link using the CPUs 105.

It will be understood and appreciated by those skilled in the art that the example flow control above may be modified or substituted with alternate flow control schemes and/or the one of more of the process steps described above may be undertaken by different components than those described without departing from the sprit and scope of the present invention.

### Static Protocol Selection

In accordance with another embodiment of the network interface device, static protocol selection is provided wherein the network device is enabled with the necessary components to support multiple protocol (i.e., multiple protocol ready). A final re-configuration of the components would either permanently or temporarily set the desired protocol from among the supported protocols. In this way, MPHBAs having essentially the same components may be mass-produced which can work with multiple protocols. Even though each MPHBA includes some protocol specific components for each supported protocol, the additional cost for these components are outweighed by the increased efficiencies associated with fewer overheads for manufacturing and inventory control compared to that otherwise associated with supplying different MPHBAs for each different protocol.

In an embodiment of the present invention, shared physical link components are provided in the MPHBA, which can be re-configured by hardware re-configuration (e.g., jumpers), software or firmware components (e.g., ASIC) that may be pre-programmed, to set the physical link components to work with one of the available network data transfer protocols supported by the network interface device. In one embodiment, the physical link components provide different reference clock signals (derived front same or different reference clocks) for each supported protocol. A link monitor and speed selector (LMSS) may be provided, which may be similar to the LMSS 40 in the earlier embodiment, except that it may be modified to function in accordance with the disclosure below. In fact, in accordance with one embodiment of the network interface device provided with static protocol selection, it can have the same component structure as the MPHBA 100 described in the earlier dynamic protocol detection and selection embodiment, except that the software, firmware or physical connections within MPHBA would have to be modified.

Using the MPHBA 100 as an example, only the firmware for one of the protocols supported by the MPHBA 100 is programmed onto the MPHBA 100 at the point of manufacturing, sale, installation or use, and the MPHBA 100 will only operate with that protocol until a different protocol firmware is programmed on the MPHBA 100. Otherwise, the MPHBA 100 may have the same functional and physical components as that shown in FIGS. 3, 4, 6 and 7.

Alternatively or in addition, the multiplexer 56 in FIG. 7 may be provided with a user settable option, which can be set to select the desired protocol from the protocols supported by the MPHBA 100, at the point of manufacturing, sale, installation, or at the time of use (e.g., by external software control).

Further, alternatively or in addition, the MPHBA 100 may be provided with other user settable options such as jumpers (not shown) or software settable switch (not shown) to enable user selection of one of the supported protocols. For example, instead of using a multiplexer 56, jumpers may be provided to manually set the functional oscillator for the desired protocol (i.e., the other oscillator is by-passed).

The physical link components 12 of the MPHBA 100 may be subject to similar process control as described in the dynamic protocol defection and selection embodiment, except that appropriate modification would be required to account for the modifications to the physical components of the physical link components 12 as discussed above. Such modification to the process is well within the capability of one skilled in the art, given the disclosure of the present invention herein.

Referring to FIG. 8, for example, the function of the LMSS 40 may be modified to omit the protocol selection function. In other words, the LMSS 40 may retain the function of detecting the protocol of the data frequency of the incoming data stream (i.e., the RX signal), but only to verify that the protocol pre-selected prior to placement of the MPHBA 100 into operation is compatible with the actual network protocol to which the MPHBA 100 is connected. In particular, the state 104 can be omitted from FIG. 8, since the static protocol selection process would not provide for system selection of another support frequency. Further, at state 168, if the RX line frequency does not match the reference frequency, the process may be configured to proceed to state 166 to repeatedly determine the actual line frequency using the frequency counter and determine if there is a final match in the actual and reference frequencies, or indicate an error after a preset number of attempts.

### Network Interface Integration On System Board

In another embodiment of the present invention, the multi-protocol network interface may be implemented on the system board (e.g., the motherboard) or other component of a network element (e.g., a server), instead of implementation as a separate and distinct HBA device. For example, referring to the schematic diagram of FIG. 9, a network interface device 208 in accordance with the present invention may be implemented as an integrated part of the motherboard and/or a component of the server 204. The foregoing discussion of the HBA embodiment is also applicable to this embodiment.

The present invention has been described above in terms of schematic diagrams and functional modules to block diagram format. It is understood that unless otherwise stated to the contrary herein, one or more functions and components may be integrated in a single physical device with associated firmware and/or software control, or one or more functions and components may be implemented in separate physical devices with separate firmware and/or software control without departing from the scope and spirit of the present invention.

It is appreciated that detailed discussion of the actual implementation of each module is not necessary for an enabling understanding of the invention. The actual implementation is well within the routine skill of a programmer and system engineer with basic understanding of HBA design and various protocol specifications, given the disclosure herein of the system attributes, functionality and inter-relationship of the various functional modules in the system. A person skilled in the art, applying ordinary skill can practice the present invention without undue experimentation.

While the invention has been described with respect to the described embodiments in accordance therewith, it will be apparent to those skilled in the art that various modifications and improvements may be made without departing from the scope and spirit of the invention. Accordingly, it is to be understood that the invention is not to be limited by the specific illustrated embodiments, but only by the scope of the appended claims.

1. A network device, comprising:
a protocol independent interface operable to receive data according to a block-based protocol of a plurality of protocols, the protocol independent interface also being operable to receive data according to a packet-based protocol of the plurality of protocols;
a serializer/deserializer operably coupled to the protocol independent interface to detect a presence or an absence of the block-based protocol;
a link monitor operable to monitor the protocol independent interface and the serializer/deserializer, wherein if the protocol independent interface is being used and the block-based protocol is absent, the link monitor directs the serializer/deserializer to detect a presence or an absence of the packet-based protocol; and
a protocol specific components operably coupled to the serializer/deserializer to enable a data transmission to a packet-based network.

2. The network device of claim 1, wherein the serializer/deserializer output is coupled to at least two protocol specific components.

3. The network device of claim 1, wherein the plurality of protocols comprise high speed standards allowing data exchanges at speeds at least on the order of 10 Gbits/s.

4-8. (canceled)

9. The network device of claim 1, wherein the link monitor sets a corresponding reference data rate for the identified protocol.

10-12. (canceled)

13. The network device of claim 1, wherein the network device comprises a protocol independent media interface layer component for handling the data at a frame level.

14-19. (canceled)

20. The network device of claim 1, wherein the network device comprises a host interface for interfacing the network device with a host network element.

21. The network device of claim 20, wherein the network device and the host interface are implemented on a host bus adaptor (HBA).

22. The network device of claim 20, wherein the host interface is a PCI bus interface.

23-33. (canceled)

34. The network device of claim 1, wherein the network device comprises a visual indicator operable to be illuminated if the protocol independent interface is in use.

35. A method for network communication, the method comprising:
detecting a use of a protocol independent interface for a data reception;
detecting a presence or an absence of data indicative of a block-based protocol;
if the protocol independent interface is being used and data indicative of the block-based protocol is absent, detecting a presence or an absence of data indicative of a packet-based protocol; and
transmitting to a packet-based network.

36. The method of claim 35, wherein the method comprises illuminating a visual indicator if the protocol independent interface is in use.

37. The method of claim 35, wherein the detecting of the presence or the absence of data indicative of the block-based protocol uses a serializer/deserializer.

38. The method of claim 35, wherein the method comprises selecting a data path based on whether data indicative of the block-based protocol is present.

39. The method of claim 35, wherein the method comprises adapting a data processor if data indicative of the block-based protocol is present.

40. The method of claim 35, wherein the block-based protocol is one of a plurality of protocols.

41. The method of claim 35, wherein the method comprises setting a reference data rate corresponding to the packet-based protocol.

42. A network-device, comprising:
an interface operable to receive data according to a block-based protocol and operable to receive data according to a packet-based protocol;
a memory device operably coupled to the interface to buffer data according to the block-based protocol and operable to buffer data according to the packet-based protocol;
a link monitor operable to monitor the interface and the memory device to detect whether received data is formatted according to the block-based protocol or the packet-based protocol; and
a hardware processor operably coupled to the link monitor and operable to format a data transmission according to a packet-based network.

43. The network-device of claim 42, wherein the link monitor is operable to change a reference data rate according to a protocol identifier.

44. The network device of claim 42, wherein the network device comprises a visual indicator operable to be illuminated if the interface is in use.

45. The network device of claim 42, wherein the memory comprises a serializer/deserializer.
